(19) United States
(12) Patent Application Publication
(10) Pub. No.: US 2006/0180256 A1
(43) Pub. Date: Aug. 17, 2006

(54) Tire pressurization system

(76) Inventor: Chander P. Mittal, Diamond Bar, CA (US)

Correspondence Address: Derrick Michael Reid, Esq., 26 La Costa Court, Laguna Beach, CA, 92651, US

(21) Appl. No.: 11/057,639

(22) Filed: Feb. 14, 2005

(51) Int. Cl. B60C 23/10

(52) U.S. Cl. 152/416

(57) ABSTRACT

A tire pressurization system is activated upon ignition for routing an ignition signal through the pressure switch to start the compressor and open a solenoid valve for pressurizing automobiles tires through a check valve and a pressure line and through tire check valves on each of the tires for maintaining tire pressures at a desired air pressure at the start of each ignition while preventing deflation of the tires back into the pressure line in passenger automobiles.

### FIELD OF THE INVENTION

The invention relates to the field of automotive tire pressurization. More particularly, the present invention relates to automatic pressurization of tire upon activating ignition of an automobile.

### BACKGROUND OF THE INVENTION

Since the introduction of rubber tires, people have been driving cars and other vehicles with tires. Tires on an automobile may sometimes have low tire pressure or inadequate pressure, or flat zero pressure in some and or all the tires of the vehicle. Drivers at times are required to inspect the tires for low tire pressures. New radial tires have not provided an ability to visually inspect tires for under inflation because even fully inflated radial tires often appear to be under-inflated. The driving public has become accustomed to driving vehicles without daily inspections when tires are not fully and properly inflated. As the average driving speeds are increased to as much as 75 mph on out of town highways, and as there is an ever increasing number of vehicles on the road, tires maintenance remain exceedingly important with the presence of lackadaisical tire inspections. As the center of gravity of new cars, like vans and sport utility vehicles, is increased with new vehicular designs, there have been a increasing number of accidents resulting in the tires digging into the roads leading to toppling of these high center of gravity vehicles. Accidents characterized as the toppling over of vehicles with low tire pressure and high centers of gravity, is increasing leading to more death, injury and property damage. Moreover, uneven pressures in tires induces vibrations in the automobile that accounts for a rough ride, increased wear and tear on the automobile, uneven wear of treads, reduced tire life and premature failure of tires including the blowouts and amounts to ever increasing unsafe driving conditions leading to death, injury and property damage. As such, there is a need for tire pressurization systems that maintained desired tire pressures.

Many tire pressurization systems have been used to maintain desired tire pressures of tires on vehicles. Most of these tire pressurization systems are exceedingly costly and not cost effectively installed on average sized passenger cars. In conventional passenger automobiles, some systems do warn the drivers when there is an under inflated pressurization of the tires. Such a warning is rarely helpful or beneficial since after the warning, the driver is looking for an exit from the highway to find a repair shop to get the tires inspected and or fixed. These systems have both inflation and deflation means. The tires are prone to accidental deflation because they utilize an external wheel valves including modified or pilot operated check valves. Additional problems associated with such external check valves, for passenger car applications, is that these valves are mounted towards the outer rim and produce an additional weight on the wheels and that requires balancing. Moreover, external check valve installations are also prone to damage from flying rocks and objects on the road, and a grind off during curb parking. With technological improvements, including the utilization of modified check valves, tires can be inflated to the correct pressure by on board tire pressurization systems, containing necessary valves, compressors and air tanks to automatically monitor and adjust tire pressures. However, such systems are used on large government, security and private vehicles, such as logistics, concrete trucks, and logging trucks, fire trucks and army vehicles. These systems require operator interaction to operate, and training is required, usually beyond the skills, experience, or patience of drivers of common passenger vehicles. These and other disadvantages are solved or reduced using the proposed invention.

### SUMMARY OF THE INVENTION

An object of the invention is to provide a tire pressurization system that activates upon ignition for maintaining pressurization of a vehicle tires without operator interaction.

Another object of the invention is to provide a tire pressurization system that activates upon ignition for maintaining pressurization of a vehicle tires without operator interaction through ignition activation.

Yet another object of the invention is to provide a tire pressurization system that activates upon ignition for maintaining pressurization of a vehicle tires without operator interaction that is cost effective for implementation in common passenger vehicles.

Still another object of the invention is to provide a tire pressurization system that activates upon ignition for maintaining pressurization of a vehicle tires without operator interaction with each ignition activation serving as a regular recurring inspection and maintenance of vehicular tire pressure.

Still another object of the invention is to provide a tire pressurization system that activates upon ignition for maintaining pressurization of a vehicle tires without operator interaction with each ignition activation serving as a regular recurring inspection and maintenance of vehicular tire pressure that is held by a check valve, one mounted on each tire, and that prohibits accidental deflation of tires through the check valve.

Still another object of the invention is to provide a tire pressurization system that activates upon ignition for maintaining pressurization of a vehicle tires without operator interaction with each ignition activation serving as a regular recurring inspection and maintenance of vehicular tire pressure without any accidental deflation of tires and to warn the driver during the inflation cycle when such tires are flat or the tires can not hold the pressure due to leakage commonly associated with a nail or other sharp object penetrating the tires, or a rupture of the tire walls or blowout of a large hole in the tire or failure of a circumferential seal between the tire and the wheel rim.

Still another object of the invention is to provide a tire pressurization system that activates upon ignition for maintaining pressurization of a vehicle tires without operator interaction with each ignition activation serving as a regular recurring inspection and maintenance of vehicular tire pressure that represents equal pressure in all tires by pressurizing all tires connected to a common point during the pressurization cycle.

Still another object of the invention is to provide a tire pressurization system that activates upon ignition for maintaining pressurization of a vehicle tires without operator interaction with each ignition activation serving as a regular recurring inspection and maintenance of vehicular tire pressure that represents equal pressure in all tires by pressurization of the lowest tire first, then to the next higher tire pressure and so on until all four tires are equalized in pressure and pressurized to the desired tire pressure.

Still another object of the invention is to provide a tire pressurization system that activates upon ignition for maintaining pressurization of a vehicle tires without operator interaction with each ignition activation serving as a regular recurring inspection and maintenance of vehicular tire pressure that represents equal pressure in all tires, and the completion of the pressurization cycle preceding depressurization of the pressure lines to atmosphere for seating a check valve tight for a positive shutoff.

Still another object of invention is to design a modified check valve that is quite small and can be mounted inside a tire valve; a two piece assembly consisting of a valve body that sticks out of the wheel rim and a pin actuated valve core threaded inside the valve body and such valve body acting as an enclosure and provide full protection from flying rocks and to be away from the curb to avoid direct grind-off during parking.

The invention is directed to a tire pressurization system that is activated upon each ignition of a passenger automobile for providing recurring sensing and maintenance of tire pressure. An onboard air tank and compressor, serve to provide needed pressurization. The automobile ignition switch provides a direct electronic line to a pressure switch that routes the electronic line directly to a solenoid valve for controlling pressure in pressurized lines that is in turn routed to the tires for pressurizing all of the tires to the same desired pressure level upon ignition. As such, the invention is a worry-free tire pressurization system that recurrently maintains proper pressurization of the tire without operator interaction and with the flat tire warning to warn the driver when the tires can not be pressurized or when the tires can not hold the pressure. These and other advantages will become more apparent from the following detailed description of the preferred embodiment.

### BRIEF DESCRIPTION OF THE DRAWING

The drawing is a block diagram of a tire pressurization system

### DETAILED DESCRIPTION OF THE PREFERRED EMBODIMENT

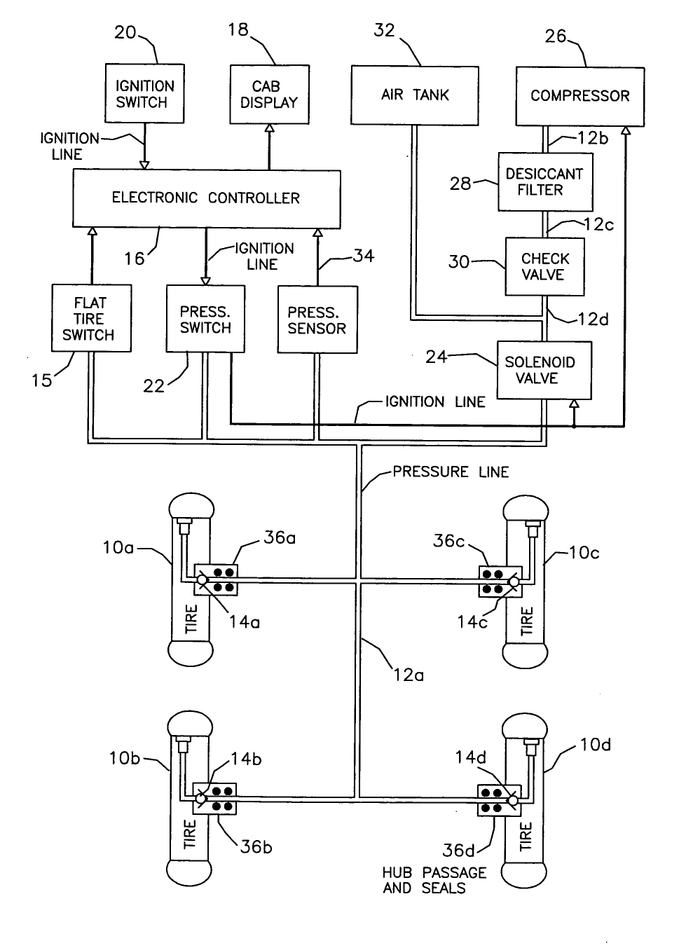

An embodiment of the invention is described with reference to the figures using reference designations as shown in FIG. 1. An automobile has four tires, 10a, 10b, 10c, and 10d that are connected to an air pressure line 12a through respective tire check valves 14a, 14b, 14c, and 14d having respective conventional hub seals, represented by 36a, 36b, 36c and 36d. The tire check valves 14a, 14b, 14c, and 14d are check valves that are preferably modified check valves, to allow for the installation of check valves inside the tire valve and to route pressurized air to conventional tire valves, not shown, of the tires 10a, 10b, 10c and 10d. A flat tire switch 15 is a pressure activated switch, and is a normally close switch that stay closed when the pressure in line 12a remains below a predetermined value for a predetermined amount of time, for example, one minute, at low pressure, for example, ten psi. Upon the expiry of a predetermined time and pressure remaining below ten psi, the flat tire switch 15 in its close position sends a signal to an electronic controller 16 that then sends a flat tire signal to a cab display 18 in the interior of the automobile to warn the driver of the automobile of an unsafe driving tire condition because of low tire pressure or a flat tire. The valve core produced by Schrader part number 45750035, Dill part number 100-GS, Haltec part number A-100-VC-1, and Halkey-Roberts part number C832A0 represents the modified check valve except for some modifications. Preferably these valve cores, without the manual actuation of the pin, should open at a very low pressure, for example, in a range of one to five psi, and preferably two psi. The valve core designs listed above can be modified by replacement of the current spring to a lighter spring sized for a two psi opening when air pressure is applied to the valve core installed in the tire valve.

An ignition switch 20 is the ignition switch of the automobile that when closed communicate an ignition signal routed from the battery, not shown, of the automobile through the electronic controller 16 to a pressure switch 22. The pressure switch 22 is connected to the pressure line 12a and is a pressure activated switch that is normally closed and that is activated when the pressure in the line 12a reaches above a predetermined value, such as thirty psi, that may be the desired operating pressure of the tires 10a, 10b, 10c, and 10d. When, the ignition switch 20 is closed and the ignition line is active and routed through the controller 16 to the pressure switch 22, the ignition line is routed through the pressure switch 22 and to a solenoid valve 24 and compressor 26 and the pressure in the line 12a is zero since it is open to the atmosphere through the solenoid valve 24 and is also below the desired operating pressure. When the compressor 26 and solenoid valve 24 are activated, the compressor 26 supplies increased air pressure to a line 12b, 12c, 12d and 12a as pressurized air. When there is no flat tire in the normal operating condition, a time function of the controller 16 is initiated to provide an output to the cab display 18 for one minute. As soon as the compressor 24 has pressurized the tires, the pressure rises or builds up above ten PSI, for example, in approximately 40 seconds, the flat tire switch opens up to turn off the timer function and the cab display 18.

However, when there is a flat tire and under normal operating conditions, a time function of controller 16 is initiated to provide an output to cab display 18 after one minute. As soon as the compressor 24 has pressurized the tires and the pressure does not build up to ten psi in one minute, the flat tire switch 15 through controller 16 will provide an output to cab display 18 to show a flat tire.

The movement of the ignition switch to the start position provides a momentary ignition line signal to power up the compressor 26 and to activate the solenoid valve 24. The pressure switch 22 is closed to route the momentary ignition line signal and then thereafter, a power signal to the compressor 26 and solenoid valve 24. Once turned on, the compressor 26 starts building up the air pressure. Upon the momentary ignition line signal, the solenoid valve 24 opens and enables the compressor pressurized air from the compressor 26 to flow to the four tires through the air pressure line 12a. The tire with the lowest air pressure of the tires 10a, 10b, 10c, and 10d, will receive the pressurized air first and then the balance of the tires will start filling in sequence based upon their tire pressure and as needed so that all of the tires 10a, 10b, 10c, and 10d reach the desired operating pressure. The tire with the lowest pressure gets inflated first by directing all the available air to this tire. Directing all the air to the lowest pressure tire reduces the time to inflate. By directing all the air to the lowest pressure tire brings up the low tire fast in air pressure and thus reduces the damage, the wear and tear of tires and increases the life of the tire including some savings in fuel and adds to the safety of both the driver and the vehicle. When at the desired pressure, the pressure switch 22 opens and the power is cut-out to both compressor 26 and solenoid valve 24 to turn off. The solenoid valve 24 in an off position now ports the air in the line 12a to atmosphere to provide a full differential across each of the check valves 14a, 14b, 14c and 14d and to provide a very tight seal for a positive shut-off and to eliminate the leakage from the tires to the atmosphere through the check valves 14a, 14b, 14c and 14d.

The compressor 26 is connected to the line 12b for routing the pressurized air through a desiccant filter 28 to a line 12c that is connected to a line check valve 30 that is connected to a line 12d for routing the pressurized air to the solenoid valve 24 that in turn routes the pressurized air into the line 12a. An air tank 32 can be connected to the line 12d so as to be connected to the solenoid valve 24 and to line 12d. The air tank 32 can be used to dampen the pulses of the air produced by the compressor 26 and also to provide an impulse of pressurized air at the desired pressure rapidly upon ignition when the ignition switch 20 is closed. A pressure sensor 34 can be added for providing specific current pressure data to the electronic controller 16 for display of tire pressure values by the cab display 18.

In operation and when ignition switch is closed and when the pressure in the line 12 is below the desired operating pressure, the ignition line signal passes through the electronic controller 16, through the pressure switch 22, and to the solenoid valve 24 for introducing an impulse of air into the line 12a for immediate pressurization of the line 12a feeding the tires 10a, 10b, 10c, and 10d with pressurized air at the desired operating pressure. The electronic controller 16 may further include a timer function for breaking the ignition signal after a predetermined time after the ignition line is active and for deactivation of the ignition signal for shutting down the compressor 26 after the expiration of the predetermined time period. Concurrently upon ignition, the compressor 26 is activated for generating more pressurized air fed through the desiccant filter 28 for filtering the pressurized air communicated through the line check valve 30. The line check valve 30 may be a conventional check valve set at one or two PSI. The line check valve 30 could also be a fixed or adjustable pressure regulator for maintaining the pressurized air at the desired operating pressure. Those skilled in the art can also set the line check valve 30 at the desired operating tire pressure of thirty PSI to control the maximum tire pressure.

The solenoid valve 24 can be a dual valve, including a passage valve for blocking air movement or for routing pressurized between lines 12d and 12a, and including a release valve for routing air from the pressure line 12a to the atmosphere for preventing over pressurization in the line 12a when the passage valve is closed during depressurization. The depressurization by the solenoid valve 24 relieves the air pressure upon the hub seals 33a, 33b, 33c and 33d of the tire check valves 14a, 14b, 14c, and 14d. The depressurization of the line 12a protects the hub seals from long exposure to pressurized air for improved longer life. With utilization of a one way check valve on each tire, the tires are prevented from accidentally deflating. The release valve of the solenoid valve 24 can have a fixed or adjustable predetermined over pressure value, such as forty psi. Such a dual valve configured solenoid valve 24 would still only require one ignition line for operational control. The pressure sensor 34 can be made integral with the pressure switch 22 for sensing pressure, controlling the solenoid valve 24, and providing a pressure reading which may be simply low or high for cab display 18. The flat tire switch 15 can be used to sense for a flat tire condition and disabling operation of the compressor 26 and solenoid valve 24 so that the compressor 26 does not continually waste energy pressuring air only to be then released to atmosphere through a flat tire.

The present invention is directed to a tire pressurization system that is activated upon the closing of the ignition switch for routing a momentary ignition signal through the pressure switch 22 to start the compressor 26 and the solenoid valve 24 for pressurizing automobiles tires 10a, 10b, 10c, and 10d through a check valve 30. The system preferably includes the desiccant filter 28 for filtering compressor air, includes a flat tire switch 15 for sensing a flat tire for display, and includes pressure switch 22 or a pressure sensor 34 for terminating pressurization at the desired air pressure to prevent over pressurization. The solenoid valve 24 may be modified to have both a passage valve for routing and blocking pressurized air from the compressor 26 and a release valve for releasing air into the atmosphere in the event of over pressurization. Those skilled in the art can make enhancements, improvements, and modifications to the invention, and these enhancements, improvements, and modifications may nonetheless fall within the spirit and scope of the following claims.

What is claimed is:

1. A system for maintaining tire pressures of tires at a desired pressure in an automobile having an ignition switch, the system comprising,
a compressor for generating pressurized air,
a solenoid valve for passing and blocking the pressurized air,
a pressure line for receiving the pressurized air through the solenoid valve and routing the pressurized air to the tires, and
a pressure switch actuated by air pressure in the pressure line and for routing an ignition signal from the ignition switch to the compressor and the solenoid upon closing of the ignition switch.

2. The system of claim 1 wherein,
the pressure switch turns off the compressor when the air pressure in the pressure line reaches the desired air pressure.

3. The system of claim 1 further comprising,
a desiccant filter for filtering the pressurized air from the compressor.

4. The system of claim 1 further comprising,
a line check valve for communicating the pressurized air from the compressor to the solenoid valve.

5. The system of claim 1 further comprising,
a flat tire switch that is activated by the air pressure in the pressurized line for generating a flat tire signal when the air pressure in the pressurized line falls below a predetermined flat air pressure for a predetermined flat time.

6. The system of claim 1 further comprising,
a flat tire switch that is activated by air pressure in the pressurized line for generating a flat tire signal when the air pressure in the pressurized line falls below a predetermined flat tire air pressure for a predetermined flat time, and
a cab display for displaying a flat tire indication upon generation of the flat tire signal.

7. The system of claim 1 further comprising,
an air tank for providing an impulse of pressurized air through the solenoid valve into the pressure line when the solenoid is turned on for dampening the pressurized air from the compressor.

8. The system of claim 1 wherein the solenoid valve comprises,
a passage valve for passage and blockage of the pressurized air from the solenoid to the pressurized line, and
a release valve for releasing air from the pressurized line into atmosphere when air pressure in the pressurized line exceeds a predetermined over pressure.

9. The system of claim 1 further comprising,
a regulator for receiving the pressurized air from the compressor and regulating the pressurized air at the desired pressure.

10. The system of claim 1 wherein,
one of the tires having a lowest air pressure receives all of the pressurized air in the pressurize line until air pressure in the one tire is equal to air pressure in another one of the tires, and
when all four tires are equalized in air pressure at the desired pressure, the compressor turns off.

11. The system of claim 1 wherein the tires have tire valve stems, the system further comprising,
hub seals for the respective tires, the hub seals being attached to the pressurived line for communicating the pressurized air through the tire valve stems and into the tires, and
tire check valves disposed in the tire valve stems, the tire check valves operating at a pressure differential between one and five psi so as to maintain air pressure in the tires at the desired pressure, the tire check valves for preventing deflation of the tires.

12. The system of claim 1 wherein,
the tires have tire valve stems, and
the solenoid valve comprises a passage valve for passage and blockage of the pressurized air from the solenoid to the pressurized line and comprises a release valve for releasing air from the pressurized line into atmosphere when air pressure in the pressurized line exceeds a predetermined over pressure,
the system further comprising,
hub seals for the respective tires, the hub seals being attached to the pressurived line for communicating the pressurized air through the tire valve stems and into the tires, and
tire check valves disposed in the tire valve stems, the tire check valves operating at a pressure differential so as to maintain air pressure in the tires at the desired pressure, the tire check valves for preventing deflation of the tires, the tire check valves being tightly seating for positively shut off when the release valve releases air to atmosphere for depressurizing the hub seals.

13. A system for maintaining tire pressure of tires at a desired pressure in an automobile having an ignition switch, the system comprising,
a compressor for generating pressurized air,
a solenoid valve for passing and blocking the pressurized air,
a pressure line for receiving the pressurized air from the solenoid valve and routing the pressurized air to the tires, and
a pressure switch actuated by air pressure in the pressure line and for routing an ignition signal from the ignition switch to the compressor and the solenoid valve upon closing of the ignition switch, the pressure switch turns off the compressor when the air pressure air in the pressure line reaches the desired air pressure.
